(19) United States
(12) Patent Application Publication
(10) Pub. No.: US 2022/0075837 A1
(43) Pub. Date: Mar. 10, 2022

(54) METHODS AND SYSTEMS FOR BROWSING TEMPORAL INFORMATION

(71) Applicant: Gavin Burke, Oceanside, CA (US)

(72) Inventor: Gavin Burke, Oceanside, CA (US)

(21) Appl. No.: 17/466,298

(22) Filed: Sep. 3, 2021

Related U.S. Application Data
(60) Provisional application No. 63/074,604, filed on Sep. 4, 2020.

(51) Int. Cl. G06F 16/9537; G06F 16/9538

(52) U.S. Cl. CPC G06F 16/9537; G06F 16/9538

(57) ABSTRACT

The preferred embodiments comprise computer-program instructions stored in a temporal-browsing module of non-transient machine-readable memories which, upon effectuation via one or more data processors, execute operations to, in a timeline, (i) retrieve, display, and locomote among indicia of a plurality of temporal information on times superlatively proximate to a present time or time specified; (ii) append a plurality of temporal information on clients bidirectionally therefrom via traversing up or down; and (iii) sequence the plurality of temporal information in accordance with temporal arguments instantiated; and, neighboring or within a calendar, (a) retrieve and display indicia on temporal information on a present or superlatively proximate month and day maintaining temporal information; (b) retrieve and display indicia on temporal information on superlatively proximate posterior and anterior months maintaining temporal information upon generating an event on an indicium; and (c) efface indicia on which events are otherwise generated to traverse towards posterior and anterior months barring temporal information on posterior and anterior months. It will be appreciated by those skilled in the computer-software art that the methods and systems disclosed herein impart efficient temporal-browsing mechanisms, the temporal information browsed relative to a present time or time specified and temporal information appended and traversed towards therefrom.

### CROSS REFERENCE TO A RELATED APPLICATION

This patent application claims priority to a co-pending U.S. Provisional application entitled “Method and System for Fetching Activities in a Middle-Out Fashion Via a Telecommunications Network” Ser. No. 63/074,604 filed on Sep. 4, 2020, the entire contents of which are hereby incorporated by reference.

### TECHNICAL FIELD

This patent application is generally directed to computationally-implemented methods and systems for browsing temporal information and, more particularly, for browsing temporal information proximate to a present time or time specified and temporal information appended and traversed towards therefrom.

### BACKGROUND

Analog timelines and calendars are relics ab antiquo. Modern information technologies mimic suboptimal analog techniques for browsing temporal information despite computers having overcome previously-insuperable technical limitations. Drawing from millennia-old inefficiencies, information technologies mechanize temporal information via temporally non-monotonic and unidirectionally-appended timelines and redundantly-traversed and misleadingly indicia-stained calendars. As the timelines append temporal information merely unidirectionally, users are suspended from traversing, supplied instead with controls to browse temporal information on posterior and anterior times in separate timelines. The calendars redundantly display months without temporal information and misleadingly retain indicia on which events are otherwise generated to traverse towards posterior and anterior months even with null temporal information on posterior and anterior months provided. In view of the foregoing, it is desirable to elicit more efficient modes of temporal browsing.

### SUMMARY

The systems and methods described in the present patent application comprise computer-program instructions stored in a temporal-browsing module of non-transient machine-readable memories which, upon effectuation via one or more data processors, execute operations to, in a timeline, (i) retrieve, display, and locomote among a plurality of indicia of temporal information upon effectuating a computer-program product or generating an event on an indicium; (ii) append temporal information on clients bidirectionally therefrom via traversing up or down (in lieu of merely unidirectionally); and (iii) sequence the plurality of temporal information in accordance with temporal arguments instantiated; and, neighboring or within a calendar, (a) retrieve and display indicia on temporal information on a present or superlatively proximate month and day maintaining temporal information; (b) retrieve and display indicia on temporal information on a superlatively proximate posterior and anterior months maintaining temporal information upon generating events on indicia; and (c) efface indicia on which events are otherwise generated to traverse towards posterior and anterior months barring temporal information on posterior and anterior months. Temporal information comprises notices, reminders, start times, due times, release times, end times, precautions, etc., which may be user-generated (from a single or plurality of user(s)), from the World Wide Web, and/or from another information system. In browsing timelines, temporal information on times superlatively proximate to a present time or time specified are retrieved and displayed at a client upon generating an event on an indicium, and the display is locomoted among the temporal information to facilitate agile traversing therefrom. Therefrom, traversing down and up appends or prepends temporal information on incrementally posterior and anterior times. In browsing calendars, temporal information on a present or superlatively proximate day and month is retrieved and displayed, and temporal information on posterior and anterior months are traversed towards therefrom via generating events on indicia, bypassing months without temporal information and effacing the indicia barring temporal information on further posterior and anterior months. In light of the foregoing, the present patent application lends solutions to the pernicious, ubiquitous problems of obliviousness to and difficulty in browsing temporal information on the future and past—especially in the near term and recent term and around specified times. The inventions that the patent application makes possible are best suited to pioneer a temporal information system.

### BRIEF DESCRIPTION OF THE DRAWINGS

FIG. 1 is a flow diagram of example routines for retrieving and displaying indicia of temporal information on times proximate to a particular time.

FIG. 2 is a flow diagram illustrating relationships between the foregoing example routines.

FIGS. 3A and 3B illustrate permutations of sequences of temporal information retrieved via the foregoing example routines.

FIG. 4 is a flow diagram of example routines for retrieving and displaying indica of temporal information on a present or superlatively proximate month or day.

FIG. 5 is a flow diagram of an example routine for mutating or effacing indicia on which events are otherwise generated to traverse towards proximate months.

FIG. 6 is a flow diagram of example routines for retrieving and displaying indicia of temporal information on superlatively proximate posterior and anterior months.

FIG. 7 illustrates examples of temporal information retrieved and indicia effaced via the foregoing example routines.

FIG. 8 illustrates an example of temporal information retrieved and an indicium effaced via the foregoing example routines.

### DETAILED DESCRIPTION OF PREFERRED EMBODIMENTS

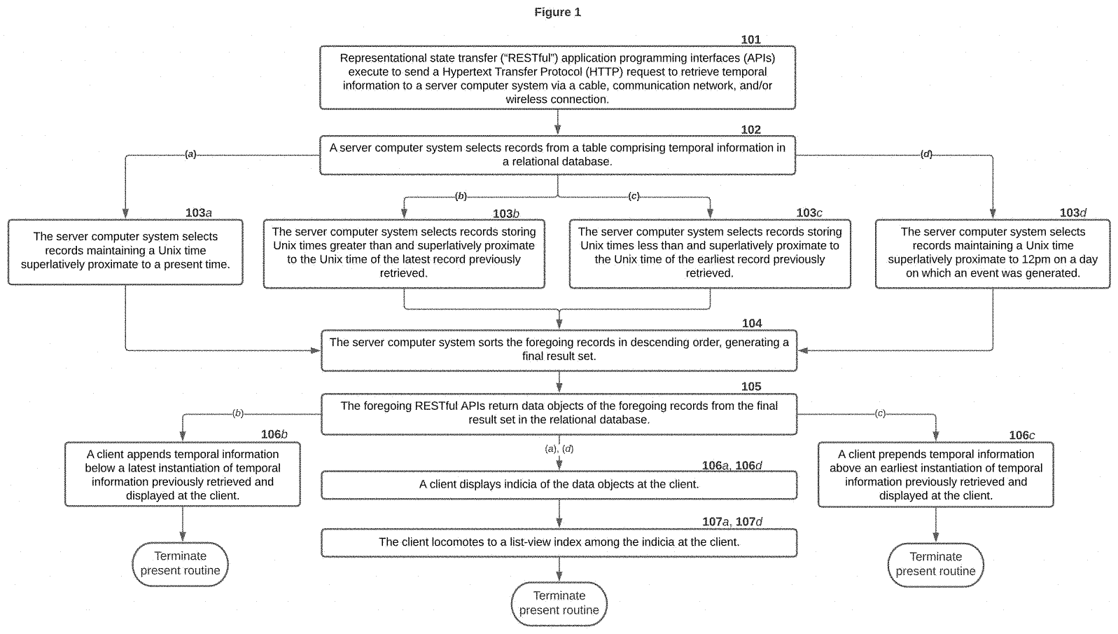

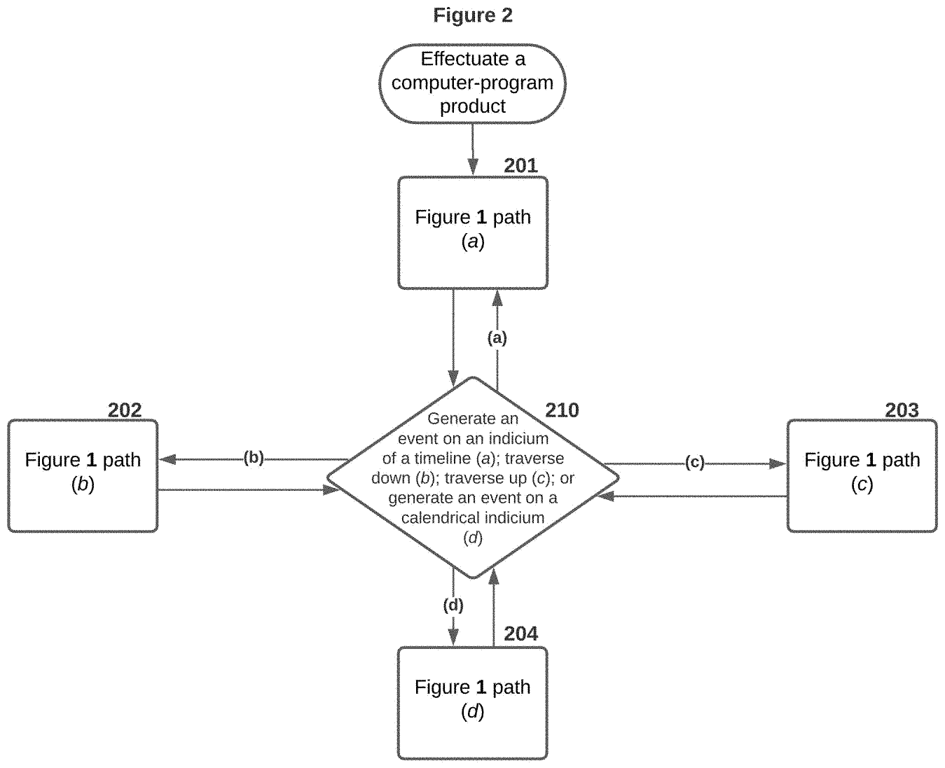

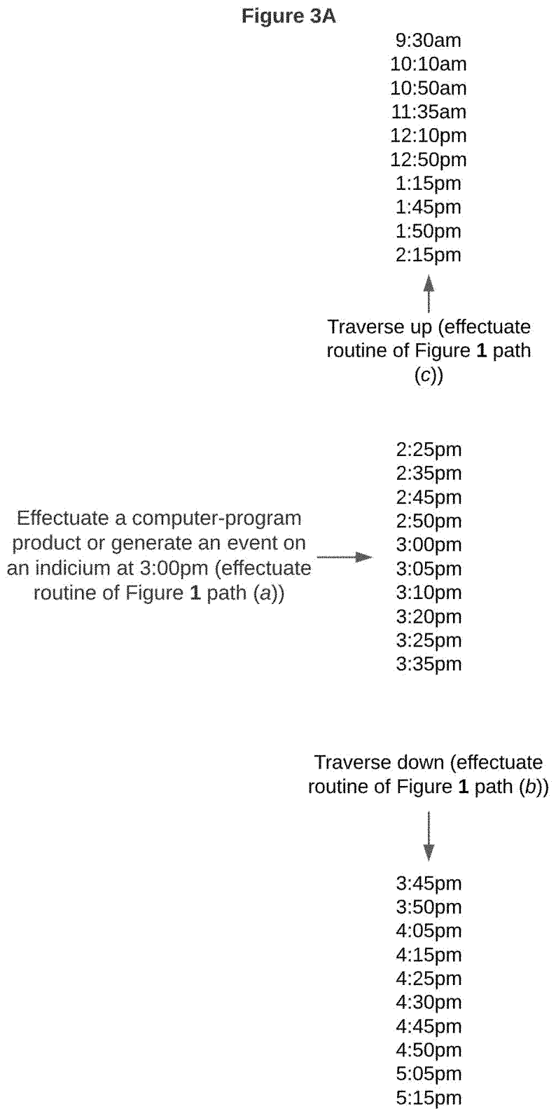

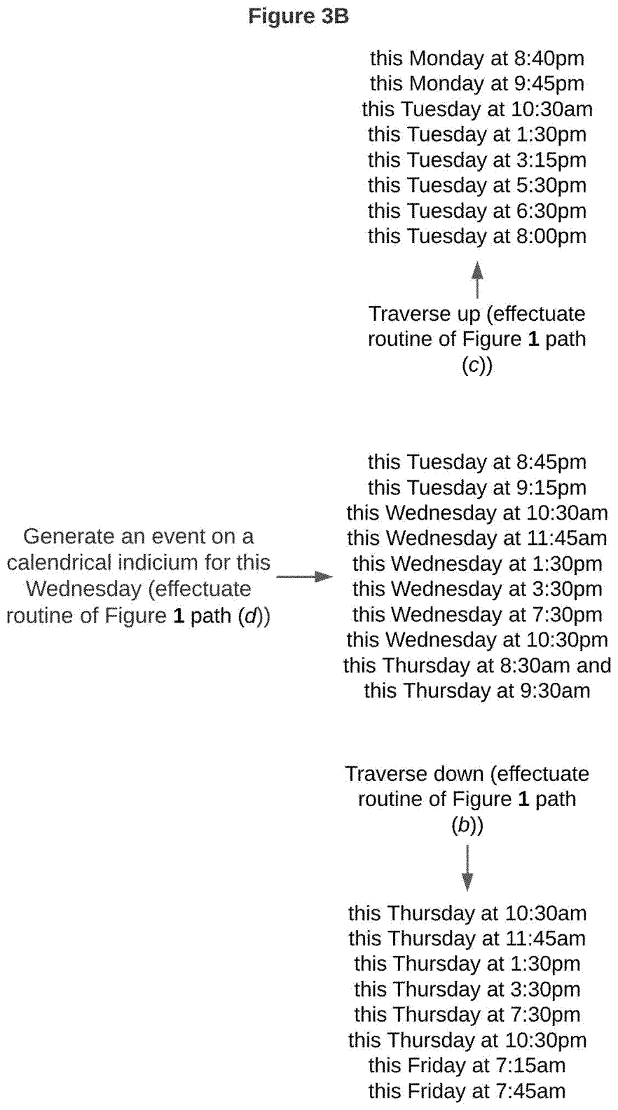

Referring now to FIG. 1 in more detail, the operations of the example routine effectuate client-side functions and database procedures stored in a temporal-browsing module that request, select, temporally sequence, retrieve, display, and locomote among indicia of a plurality of temporal information on times superlatively proximate to a present time. The example routine is invoked via an event at a client, i.e., effectuating a computer-program product or the like or generating an event on an indicium. Such a computer-program product can be installed by any suitable software installation procedure, as is well known in the art. In a particular embodiment, at least a portion of the software instructions may also be downloaded as application software over a cable, communication network, and/or wireless connection from a server to a smartphone, laptop, personal computer, tablet, or other data-processing device.

Accordingly, upon generation of an event on an indicium or effectuation of a computer-program product, in step 101, representational state transfer (“RESTful”) application programming interfaces (APIs) execute to, via a cable, communication network, and/or wireless connection, send a Hypertext Transfer Protocol (HTTP) request to retrieve temporal information to a server computer system, the server comprising some combination of hardware and/or software capable of handling and executing the non-transient machine-readable instructions discussed herein. Although a RESTful API and HTTP are described herein, other techniques for sending a request to retrieve temporal information from a server are possible.

Referring now to step 102, the server computer system selects records from a table comprising temporal information, which may be stored in a relational database. The preferred embodiment of the database is discussed herein as records in a table in a relational database merely for convenience. One skilled in the art will appreciate that, in alternative embodiments, the data could be stored in other types of data structures (e.g., as a hierarchical or object-oriented database). The one or more non-transient machine-readable memory components may include, e.g., read-only memory (ROM); random-access memory (RAM); storage including magnetic disk storage media; solid state disks (SSDs); optical storage media; flash memory devices; and/or any other mechanism for storing or transmitting information in a form readable by a machine (e.g., a computing device). The one or more data processors that execute the foregoing machine-readable instructions may be implemented, e.g., by a physical or virtual general-purpose computer having a central processor, memory, disk or other mass storage, communication interface(s), input/output (I/O) device(s), and/or other peripherals.

The server computer system then follows any of four execution paths which may be chosen based on user input, and identifies which of the plurality of temporal information evince times
superlatively proximate to a present time (103a),
superlatively proximate and posterior to a latest instantiation of temporal information previously retrieved (103b),
superlatively proximate and anterior to an earliest instantiation of temporal information previously retrieved (103c), and/or
superlatively proximate to a time specified (103d).

Accordingly, the server computer system selects records storing Unix times greater than or less than and superlatively proximate to the Unix time of the latest or earliest record previously retrieved; or selects records maintaining a Unix time superlatively proximate to a present day or 12 pm on a day on which an event was generated.

Causing sequential display of the temporal information based on an associated temporal parameter and generating a final result set, the server computer system then proceeds towards sorting the foregoing records in descending order in step 104. In a particular embodiment, the temporal information may be sorted via partitioning then dividing and conquering temporal information on the future and past. In another embodiment, to intersperse temporal information of lesser temporal proximity but greater exigency, by data-mining techniques or the like, the present routine may execute further operations comprising generating non-monotonic temporal sequences.

The foregoing RESTful APIs then return data objects of the foregoing records from the final result set in the relational database in step 105. Bidirectionally appending temporal information on proximate times in a timeline, a client either appends (106b) or prepends (106c) temporal information below or above a latest or earliest instantiation of temporal information previously retrieved and displayed at the client and then terminates. Processors of the client otherwise display indicia of the data objects at the client in steps 106a and 106d. Positioning the display among said temporal information on times superlatively proximate to a present time or time specified facilitates agility in traversing up and down upon retrieval and display. Accordingly, in steps 107a and 107d, processors of the client locomote towards a list-view index among the indicia at the client and ultimately terminate the present routine.

Referring now to FIG. 2 in more detail, the flow diagram illustrates relationships between and events which effectuate the foregoing routines. Following effectuation of a computer-program product and execution of FIG. 1 path (a), any of the foregoing four routines may effectuate at decision block 210, i.e., via generating an event on an indicium at 201 (executing steps 101, 102, 103a, 104, 105, 106a, and 107a (referred to as “FIG. 1 path (a)”)); traversing down at 202 (executing steps 101, 102, 103b, 104, 105, and 106b (referred to as “FIG. 1 path (b)”)); traversing up at 203 (executing steps 101, 102, 103c, 104, 105, and 106c (referred to as “FIG. 1 path (c)”)); or generating an event on a calendrical indicium at 204 (executing steps 101, 102, 103d, 104, 105, 106d and 107d (referred to as “FIG. 1 path (d)”)).

Referring now to FIGS. 3A and 3B in more detail, the drawings illustrate permutations of sequences of temporal information retrieved via the foregoing example routines. The temporal information and corresponding events of FIG. 3A comprise temporal information on times from 2:25 pm to 3:35 pm upon effectuating a computer-program product or generating an event on an indicium at 3:00 pm as the routine of FIG. 1 path (a) effectuates; temporal information on incrementally posterior times upon traversing down, i.e., from 3:45 pm to 5:15 pm as the routine of FIG. 1 path (b) effectuates; and temporal information on incrementally anterior times upon traversing up, i.e., from 9:30 am to 2:15 pm as the routine of FIG. 1 path (c) effectuates. The temporal information and corresponding events of FIG. 3B comprise temporal information on times from a Tuesday at 8:45 pm to a Thursday at 9:30 am upon generating an event on a calendrical indicium as the routine of FIG. 1 path (d) effectuates; temporal information on incrementally posterior times upon traversing down, i.e., from a Thursday at 10:30 am to a Friday at 7:45 am as the routine of FIG. 1 path (b) effectuates; and temporal information on incrementally anterior times upon traversing up, i.e., from a Monday at 8:40 pm to a Tuesday at 8:00 pm as the routine of FIG. 1 path (c) effectuates. The result is displaying indicia of temporal information on times proximate to a present time or time specified and temporal information appended and traversed towards therefrom in a timeline at one or more clients.

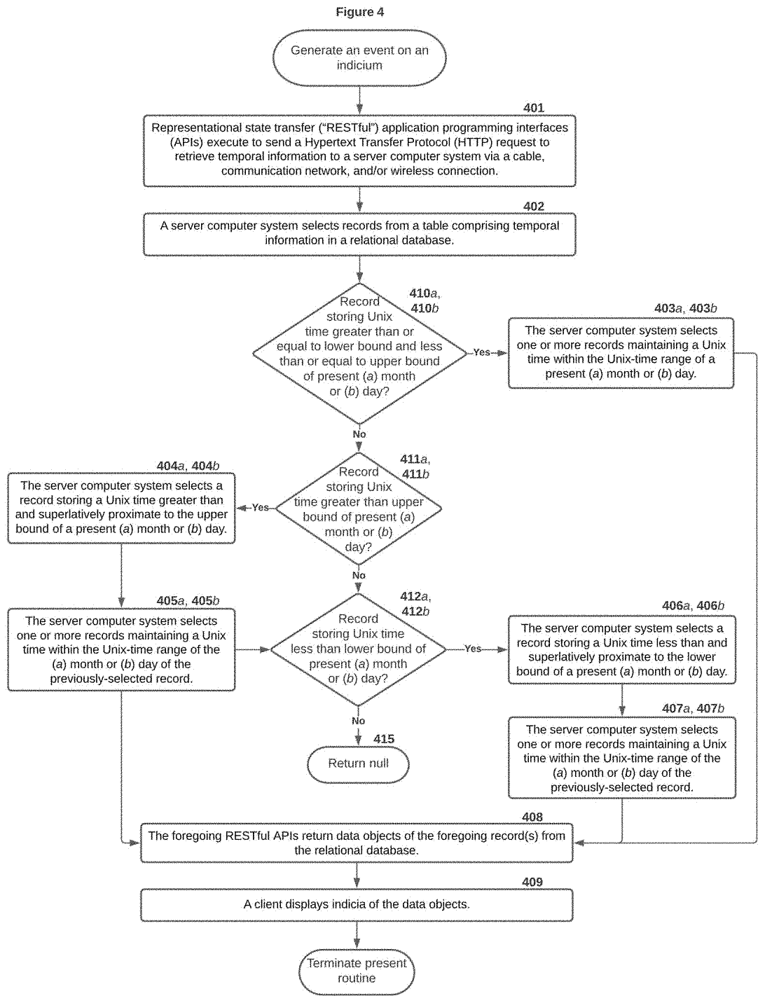

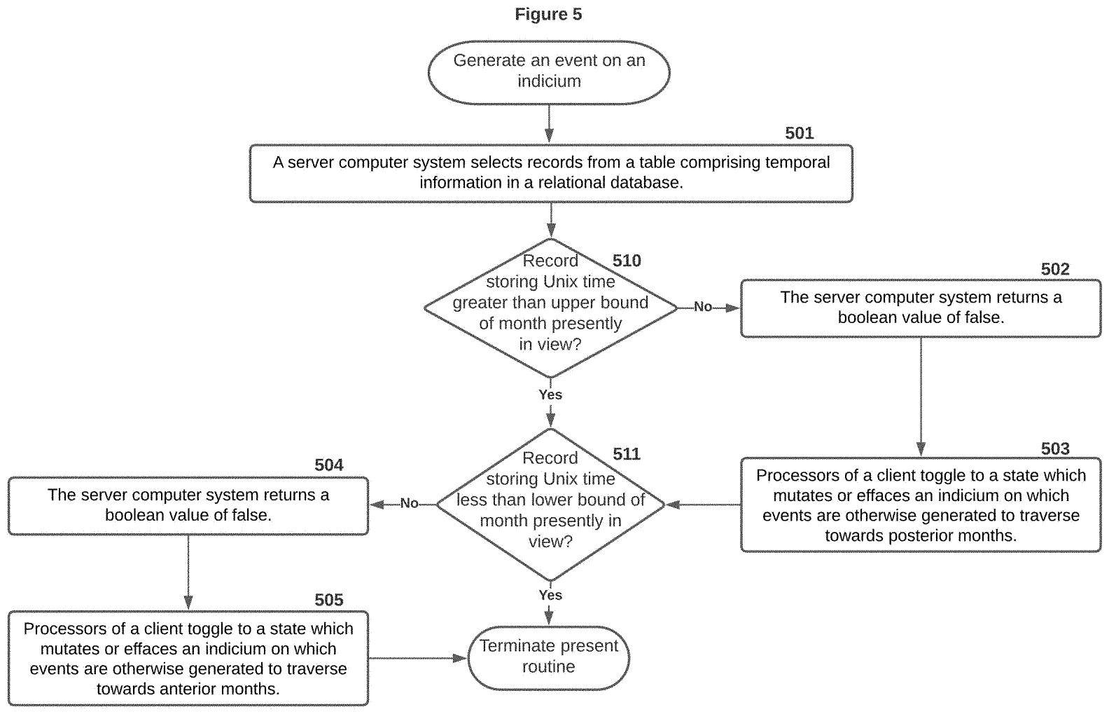

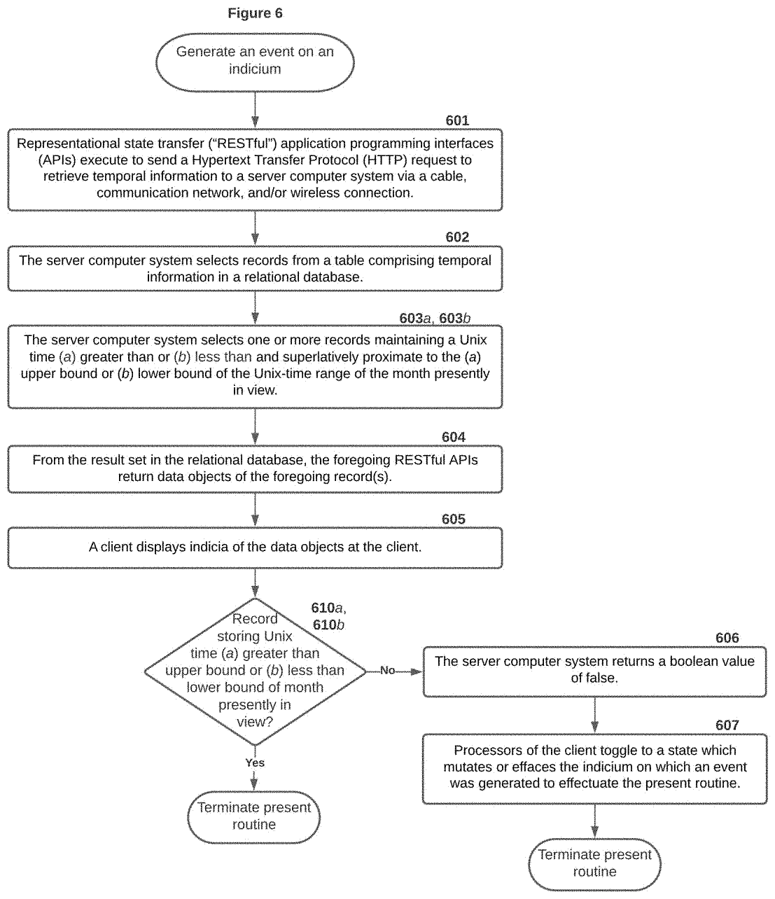

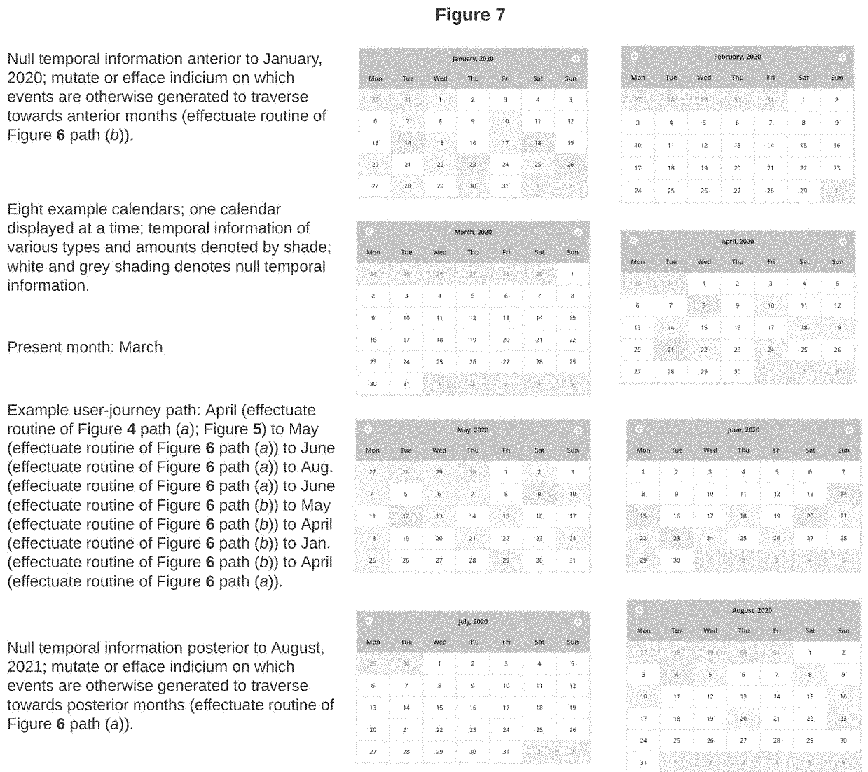

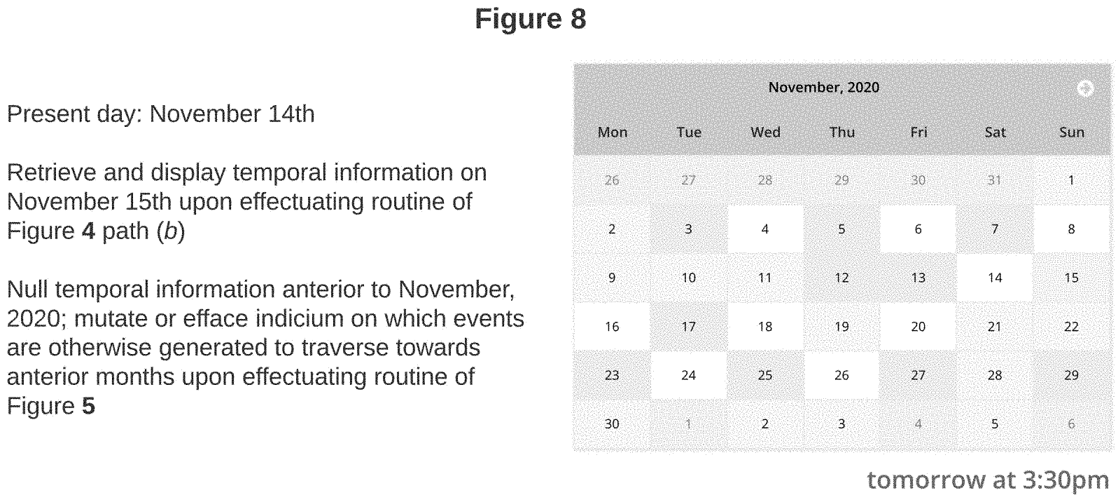

Referring now to FIG. 4 in more detail, the example routine retrieves and displays temporal information on a present or superlatively proximate month or day. Accordingly, representational state transfer application programming interfaces execute to send a Hypertext Transfer Protocol (HTTP) request to retrieve temporal information to a server computer system via a cable, communication network, and/or wireless connection in step 401; and a server computer system selects records from a table comprising temporal information in a relational database at 402. In steps 410a, 410b; 403a, 403b; 404a, 404b; 411a, 411b; 405a, 405b; 406a, 406b; 412a, 412b; and 407a, 407b, processors of the server computer system follow one of two execution paths to select temporal information relative to the Unix-time bounds of a (a) day or (b) month. To identify if there is temporal information on a present month or day, at the first decision block (410a, 410b), processors of the server computer system check for a record storing a Unix time greater than or equal to the lower bound and less than or equal to the upper bound of a present (a) month or (b) day. The server computer system then either selects one or more records maintaining a Unix time within the Unix-time range of a present (a) month or (b) day (403a, 403b) then bypasses towards step 408; or, barring such a record, proceeds towards the second decision block (411a, 411b) and checks for a record storing a Unix time greater than the upper bound of a present (a) month or (b) day. The server computer system then either selects a record storing a Unix time posterior and superlatively proximate to a present (a) month or (b) day (404a, 404b), selects records within the Unix-time range of the (a) month or (b) day (405a, 405b), then bypasses towards step 408; or, barring such a record, proceeds towards the third decision block (412a, 412b) and checks for a record storing a Unix time less than the lower bound of a present (a) month or (b) day. The server computer system then either selects a record storing a Unix time anterior and superlatively proximate to a present (a) month or (b) day (406a, 406b), selects records within the Unix-time range of the (a) month or (b) day (407a, 407b), then proceeds towards step 408; or, barring such a record, returns a null value at 415. The foregoing representational state transfer application programming interfaces then return data objects of the foregoing record(s) from the relational database in step 408; and a client displays indicia of the data objects at 409.

Referring now to FIG. 5 in more detail, the example routine mutates or effaces indicia on which events are otherwise generated to traverse towards proximate months barring temporal information on posterior and anterior months. Accordingly, a server computer system selects records from a table comprising temporal information in a relational database at step 501; then checks for a record storing a Unix time greater than the upper bound of a month presently in view at decision block 510. The server computer system then proceeds towards decision block 511; or, barring such a record, returns a boolean value of false in step 502 for a client to toggle to a state which mutates or effaces an indicium on which events are otherwise generated to traverse towards posterior months at 503 then proceeds towards decision block 511 to check for a record storing a Unix time less than the lower bound of a month presently in view. The present routine then terminates; or, barring such a record, the server computer system returns a boolean value of false in step 504 for processors of a client toggle to a state which mutates or effaces an indicium on which events are otherwise generated to traverse towards anterior months at 505; then the present routine terminates.

Referring now to FIG. 6 in more detail, the example routines retrieve and display temporal information on superlatively proximate posterior and anterior months. At a server computer system, temporal information evincing times on a present month; or, barring temporal information on a present month, temporal information on a superlatively proximate month are returned for display at one or more clients. Accordingly, representational state transfer application programming interfaces execute to send a Hypertext Transfer Protocol (HTTP) request to retrieve temporal information to a server computer system via a cable, communication network, and/or wireless connection in step 601; and the server computer system selects records from a table comprising temporal information in a relational database at 602. In steps 603a, 603b; and 610a, 610b, processors of the server computer system follow one of two execution paths to select temporal information relative to the (a) upper bound or (b) lower bound of the Unix-time range of a month presently in view. The server computer system then further selects one or more records maintaining a Unix time (a) greater than or (b) less than and superlatively proximate to the (a) upper bound or (b) lower bound of the Unix-time range of the month presently in view (603a, 603b). From the result set in the relational database, the foregoing RESTful APIs return data objects of the foregoing record(s) in step 604; and a client displays indicia of the data objects at the client at 605. Barring temporal information on a posterior or anterior month, an indicium on which events are otherwise generated to traverse towards posterior or anterior months is effaced. Accordingly, the server computer system then proceeds towards the decision block (610a, 610b) to check for a record storing a Unix time (a) greater than the upper bound or (b) less than the lower bound of month presently in view. The present routine then terminates; or, barring such a record, the server computer system returns a boolean value of false in step 606; processors of the client toggle to a state which mutates or effaces the indicium on which an event was generated to effectuate the present routine at 607; then the present routine terminates.

Referring back to FIG. 4 and FIG. 6, one of two execution paths are followed which retrieve temporal information relative to
the temporal bounds of a day (executing steps 401, 402, 410a, 403a, 411a, 404a, 405a, 412a, 415, 406a, 407a, 408, and/or 409 (referred to as “FIG. 4 path (a)”));
the temporal bounds of a month (executing steps 401, 402, 410a, 403b, 411b, 404b, 405b, 412b, 415, 406a, 407b, 408, and/or 409 (referred to as “FIG. 4 path (b)”));
the upper temporal bound of a month (executing steps 601, 602, 603a, 604, 605, 610a, 606, and/or 607 (referred to as “FIG. 6 path (a)”)); or
the lower temporal bound of a month (executing steps 601, 602, 603b, 604, 605, 610b, 606, and/or 607 (referred to as “FIG. 6 path (b)”)).

Referring now to FIG. 7 in more detail, the drawing illustrates months traversed towards and indicia effaced via the example routines of FIG. 4 path (a), FIG. 5, FIG. 6 path (a), and FIG. 6 path (b). In an example user-journey path, a user traverses from April to May to June to August to June to May to April to February to January to February, effectuating the routines of FIG. 4 path (a) and FIG. 5 upon first traversing to a calendar; and the routines of FIG. 6 path (a) and FIG. 6 path (b) upon traversing to posterior and anterior months therefrom. Upon first traversing to a calendar, temporal information on April is displayed at one or more clients as the present month is March; there is null temporal information on March; and the routine of FIG. 4 path (a) executes. Upon traversing from June to August, July is bypassed and the indicium on which events are otherwise generated to traverse towards posterior months effaces via the routine of FIG. 6 path (a) as there is null temporal information on July nor posterior to August; and, upon traversing to January, the indicium on which events are otherwise generated to traverse towards anterior months effaces as there is null temporal information anterior to January.

Referring now to FIG. 8 in more detail, the drawing illustrates temporal information retrieved and an indicium effaced via the example routines of FIG. 4 path (b) and FIG. 5. Temporal information on November 15th is retrieved and displayed at one or more clients as the present day is November 14th; there is null temporal information on the present day; and the routine of FIG. 4 path (b) executes. The indicium on which events are otherwise generated to traverse towards anterior months effaces as there is null temporal information anterior to November and the routine of FIG. 5 executes.

### Implementation Options

It should be understood that the example embodiments described above may be implemented in many different ways. The embodiments may be implemented by data processors located within personal or laptop computers, servers, smartphones, tablets, mobile devices, embedded machines, and other computer systems. In some instances, the various “data processors” may each be implemented by a physical or virtual general-purpose computer having a central processor, memory, disk or other mass storage, communication interface(s), input/output (I/O) device(s), and other peripherals. The general-purpose computer is transformed into the processors and executes the methods described above, for example, by loading software instructions into the computer, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system (e.g., one or more central processing units, disks, various memories, input/output ports, network ports, etc.) that enables the transfer of information between the elements. One or more central processor units are attached to the system bus and provide for the execution of computer instructions. Also attached to the system bus are typically I/O device interfaces for connecting the disks, memories, and various input and output devices. Network interface(s) allow connections to various other devices attached to a network. One or more memories provide volatile and/or non-volatile storage for computer software instructions and data used to implement an embodiment. Disks or other mass storage provides non-volatile storage for computer software instructions and data used to implement, for example, the various procedures described herein.

Embodiments may therefore typically be implemented in hardware, custom designed semiconductor logic, Application Specific Integrated Circuits (ASICs), Field Programmable Gate Arrays (FPGAs), firmware, software, or any combination thereof.

In certain embodiments, the procedures, devices, and processes described herein are a computer-program product, including a computer-readable medium (e.g., a removable storage medium such as one or more DVD-ROMs, CD-ROMs, diskettes, tapes, etc.) that provides at least a portion of the software instructions for the system or the method. Such a computer-program product can be installed by any suitable software installation procedure, as is well known in the art. In another embodiment, at least a portion of the software instructions may also be downloaded as application software over a cable, communication network, and/or wireless connection from a server to a smartphone, laptop, personal computer, tablet, or other device.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read-only memory (ROM); random-access memory (RAM); storage including magnetic disk storage media; solid state drives; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc. It also should be understood that the block and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus the computer systems described herein are intended for purposes of illustration only and not as a limitation of the embodiments.

The above description has particularly shown and described example embodiments. However, it will be understood by those skilled in the art that various changes in form and details may be made therein without departing from the legal scope of this patent as encompassed by the appended claims.

1. One or more non-transient machine-readable storage mediums comprising computer-program instructions which, upon effectuation via one or more processors of a client, execute operations to retrieve and display indicia of a plurality of temporal information, the operations comprising:
maintaining a plurality of temporal information for viewing by one or more users of a computer-program product, wherein the plurality of temporal information maintains an associated temporal parameter;
identifying which of the plurality of temporal information evince times superlatively proximate to a present time, superlatively proximate and posterior to a latest instantiation of temporal information previously retrieved, or superlatively proximate and anterior to an earliest instantiation of temporal information previously retrieved;
causing automated sequential display of the temporal information based on the associated temporal parameter; and
bidirectionally appending temporal information on times proximate to a present time in a timeline via execution of additional operations comprising:
at one or more clients:
by one or more processors of the one or more clients:
retrieving and displaying indicia of temporal information on times superlatively proximate to a present time;
in response to traversing down:
appending temporal information on incrementally posterior times; and
in response to traversing up:
prepending temporal information on incrementally anterior times.

2. The one or more non-transient machine-readable storage mediums as recited in claim 1, further comprising the storage of computer-program instructions which, upon effectuation via one or more processors of the client, execute further operations comprising positioning the indicia among said temporal information on times superlatively proximate to a present time.

3. The one or more non-transient machine-readable storage mediums as recited in claim 1, further comprising the storage of computer-program instructions which, upon effectuation via one or more processors of the client, execute further operations comprising retrieving and displaying indicia of temporal information on times superlatively proximate to a time specified.

4. The one or more non-transient machine-readable storage mediums as recited in claim 3, further comprising the storage of computer-program instructions which, upon effectuation via one or more processors of the client, execute further operations comprising positioning the indicia among said temporal information on times superlatively proximate to a time specified.

5. The one or more non-transient machine-readable storage mediums as recited in claim 1, wherein computer-program instructions execute additional operations comprising:
in response to traversing down after having retrieved and displayed indicia of temporal information on times superlatively proximate to a present time, appending temporal information on incrementally posterior times below a lowest-positioned and latest instantiation of temporal information previously retrieved and displayed at the client.

6. The one or more non-transient machine-readable storage mediums as recited in claim 1, wherein computer-program instructions execute additional operations comprising:
in response to traversing up after having retrieved and displayed indicia of temporal information on times superlatively proximate to a present time, prepending temporal information on incrementally anterior times above a highest-positioned and earliest instantiation of temporal information previously retrieved and displayed at the client.

7. A computationally-implemented method of retrieving and displaying indicia of temporal information on a present or superlatively proximate month, the method comprising:
at a database:
using one or more non-transient machine-readable storage mediums:
maintaining a plurality of temporal information for viewing, upon request, by one or more users;
for each of the plurality of temporal information, maintaining an associated temporal parameter; and
at one or more processors of a server computer system:
in response to the generation of an event on an indicium:
either identifying which of the plurality of temporal information evince times on a present month;
or, barring temporal information on a present month, identifying which of the plurality of temporal information evince times on a superlatively proximate month; and
causing a return of the temporal information by the server computer system and a retrieval and display of indicia of the temporal information as requested by one or more clients, by further via a database:
using one or more non-transient machine-readable storage mediums:
at one or more processors of a server computer system:
in response to the generation of an event on an indicium:
querying a plurality of temporal information;
either selecting temporal information on a present month;
or, barring temporal information on a present month, selecting temporal information on a superlatively proximate month; and
at one or more processors of the one or more clients:
retrieving and displaying indicia of said temporal information.

8. The computationally-implemented method as recited in claim 7, further comprising either displaying indicia on temporal information on a present day; or, barring temporal information on a present day, displaying indicia on temporal information on a superlatively proximate day.

9. The computationally-implemented method as recited in claim 7, further comprising, via one or more processors of the client, mutating or effacing an indicium on which events are otherwise generated to traverse towards posterior months barring temporal information on posterior months.

10. The computationally-implemented method as recited in claim 7, via one or more processors of the server computer system, selecting temporal information on a superlatively proximate anterior month maintaining temporal information using one or more non-transient machine-readable memories.

11. The computationally-implemented method as recited in claim 7, via one or more processors of the server computer system, either selecting temporal information on a present month; or, barring temporal information on a present month, selecting a superlatively proximate month using one or more non-transient machine-readable memories.

12. A computationally-implemented method of retrieving and displaying indicia of temporal information on a posterior or anterior month traversed towards in response to the generation of an event on an indicium, the method comprising:
at a database:
using one or more non-transient machine-readable storage mediums:
maintaining a plurality of temporal information for viewing, upon request, by one or more users;
for each of the plurality of temporal information, maintaining an associated temporal parameter; and
at one or more processors of a server computer system:
identifying which of the plurality of temporal information evince a time on a superlatively proximate posterior or anterior month maintaining temporal information; and
causing a return of the temporal information by the server computer system and a retrieval and display indicia of the temporal information as requested by one or more clients, by further via a database:
using one or more non-transient machine-readable storage mediums:
at one or more processors of a server computer system:
in response to the generation of an event on an indicium:
querying a plurality of temporal information;
selecting temporal information on a superlatively proximate posterior month maintaining temporal information; or
selecting temporal information on a superlatively proximate anterior month maintaining temporal information; and
by at least one of the clients:
retrieving and displaying indicia of said temporal information.

13. The computationally-implemented method as recited in claim 12, further comprising mutating or effacing an indicium on which events are otherwise generated to traverse towards posterior months barring temporal information on posterior months.

14. The computationally-implemented method as recited in claim 12, further comprising mutating or effacing an indicium on which events are otherwise generated to traverse towards anterior months barring temporal information on anterior months.
